(19) United States
(12) Patent Application Publication
(10) Pub. No.: US 2011/0096541 A1
(43) Pub. Date: Apr. 28, 2011

(54) BACKLIT TOUCH BUTTON ASSEMBLY

(75) Inventors: CHIH-HUANG LIEN, Miao-Li County (TW); HUI-TING SHEN, Miao-Li County (TW); BIN HUANG, Shenzhen City (CN); SHAO-REN DONG, Shenzhen City (CN); XIAO HU, Shenzhen City (CN)

(73) Assignees: INNOCOM TECHNOLOGY (SHENZHEN) CO., LTD., Shenzhen City (CN); INNOLUX DISPLAY CORP., Miao-Li County (TW)

(21) Appl. No.: 12/701,715

(22) Filed: Feb. 8, 2010

(30) Foreign Application Priority Data
Oct. 28, 2009 (CN) 200910308957.1

(51) Int. Cl. F21V 1/00

(52) U.S. Cl. 362/235

(57) ABSTRACT

A backlit touch button assembly includes a circuit board, one or more light sources, a reflecting plate, and a marked strip. The light sources are positioned on the circuit board. The reflecting plate and the marked strip are attached to opposite sides of the circuit board. The reflecting plate defines one or more optical grooves receiving the light sources. Each optical groove has a reflecting portion. The circuit board defines one or more through holes adjacent to the light sources and corresponding to the reflecting portion of the optical grooves. The reflecting portion has a first reflecting surface, a second reflecting surface, and a third reflecting surface. The first reflecting surface and the third reflecting surface meet the second reflecting surface, respectively, at an angle.

### BACKGROUND

1. Technical Field

The present disclosure relates generally to a plurality of backlit touch buttons and, more particularly, to a backlit touch button assembly used in a portable electronic device.

2. Description of Related Art

A frequently used backlit touch button assembly includes a plurality of light sources, a printed circuit board (PCB), a light guide plate, and a marked strip. The light sources and the light guide plate are positioned between the PCB and the marked strip, and the light sources are positioned around the light guide plate. A surface of the PCB opposite to the light guide plate is coated with a reflecting layer. The marked strip is printed with a plurality of patterns. Light from the light sources is incident upon the marked strip after passing the light guide plate. Other light from the light sources is reflected by the reflecting layer of the PCB, and passes through the light guide plate before reaching the marked strip. The marked strip is thus illuminated by the light sources. The light sources start to emit light when the marked strip is touched by an user.

However, since the light sources are positioned around the light guide plate, the areas adjacent to the light sources are generally brighter than others, resulting in uneven illumination of the buttons.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an embodiment of a backlit touch button assembly.

FIG. 2 is an exploded, isometric view of the backlit touch button assembly of FIG. 1.

FIG. 3 is similar to FIG. 2, but viewed from another aspect.

FIG. 4 is a cross-section of the backlit touch buttons of FIG. 1, taken along the line IV-IV.

FIG. 5 is an enlarged view of a circle portion V of FIG. 4.

FIG. 6 is a partial cross-section view of another embodiment of a backlit touch button.

### DETAILED DESCRIPTION

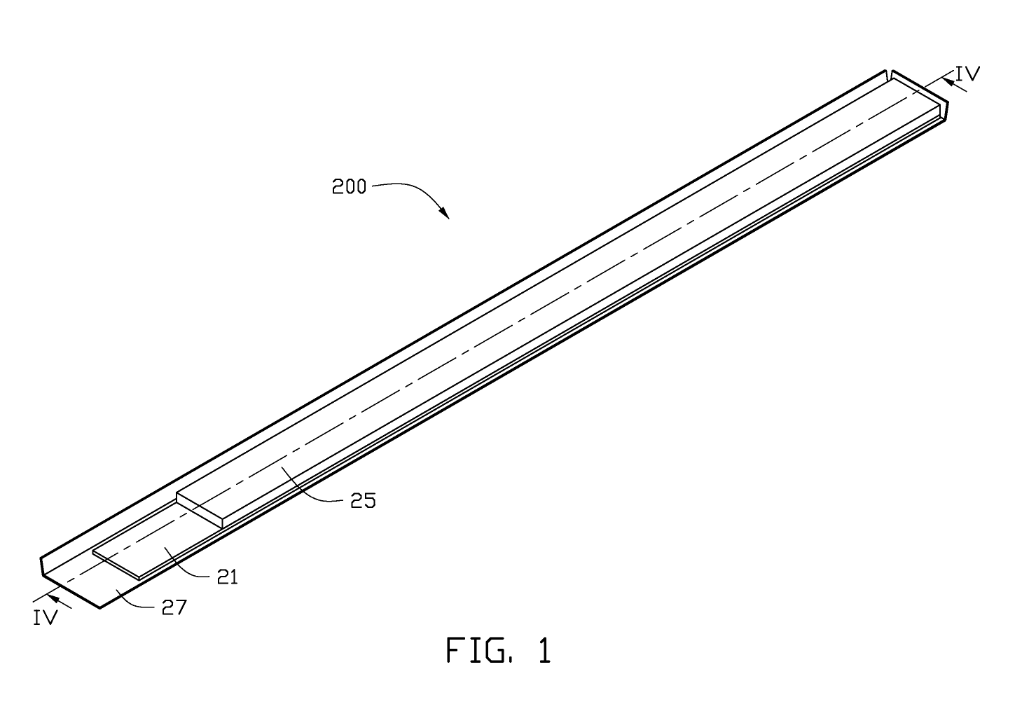

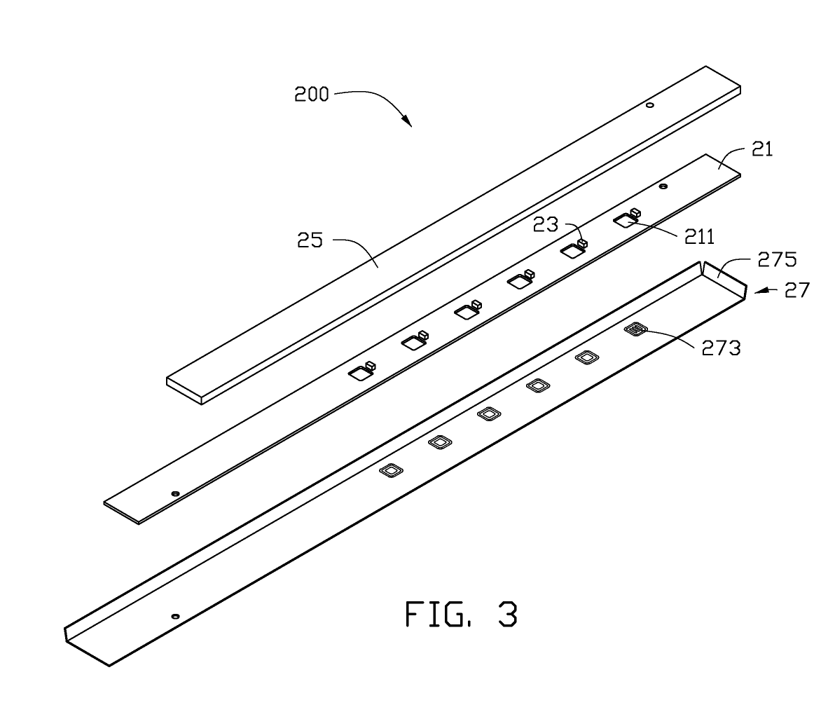

Referring to FIGS. 1 through 3, an embodiment of a backlit touch button assembly 200 includes a circuit board 21, one or more light sources 23, a reflecting plate 25, and a marked strip 27. In the illustrated embodiment, the backlit touch button assembly 200 includes six light sources 23. The circuit board 21 is a rectangular capacitive PCB. The circuit board 21 defines six through holes 211. The through holes 211 are substantially rectangular. A sensing area of the circuit board 21 is positioned around each through hole 211. The light sources 23 are light emitting diodes (LEDs), and each light source 23 is positioned on the circuit board 21 adjacent to one corresponding through hole 211. The reflecting plate 25 is of a reflective material, such as, for example, a piece of white plastic sheet.

The reflecting plate 25 defines six optical grooves 253, where each optical groove 253 includes a reflecting portion 2531 and a receiving portion 2533. The reflecting portion 2531 corresponds to the through hole 211 of the circuit board 21. The receiving portions 2533 is configured for receiving the light sources 23. The reflecting portion 2531 is configured to reflect light through the through hole 211. The reflecting plate 25 is adhered to the circuit board 21 via a double-sided adhesive, with each light source 23 received in one corresponding receiving portion 2533, and the through holes 211 opposite to the reflecting portions 2531. It should be pointed out that the reflecting plate 25 may be fixed to the circuit board 21 by means of other securing or fastening methods, such as using screws.

The marked strip 27 includes a main body 271, six marking patterns 273, and a sidewall 275. The main body 271 is non-transparent, and the marking patterns 273 is transparent. The sidewall 275 extends from an edge of the main body 271. The marking patterns 273 are embedded in the main body 271. The marked strip 27 is attached to the circuit board 21 with the marking patterns 273 corresponding to the through hole 211 of the circuit board 21. As such, part of the light from the light sources 23 is incident on the marked strip 27 after passing through the through hole 211, and the other part of the light passes through the through hole 211 after being reflected by the optical grooves 253. Therefore, the marking patterns 273 of the marked strip 27 are sufficiently illuminated by the light sources 23, thereby becoming clearly visible under dark ambient conditions. Contact with the marking patterns 273 by the user is detected by the sensing areas of the circuit board 21 around the through holes 211, and the light sources 23 emit light correspondingly.

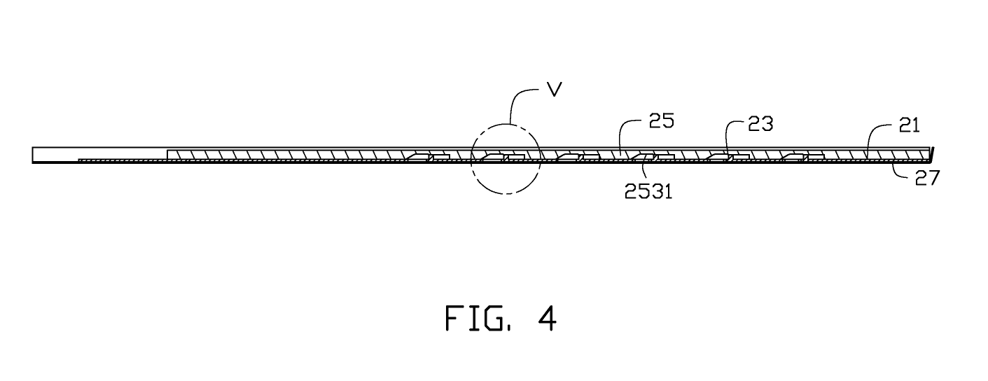

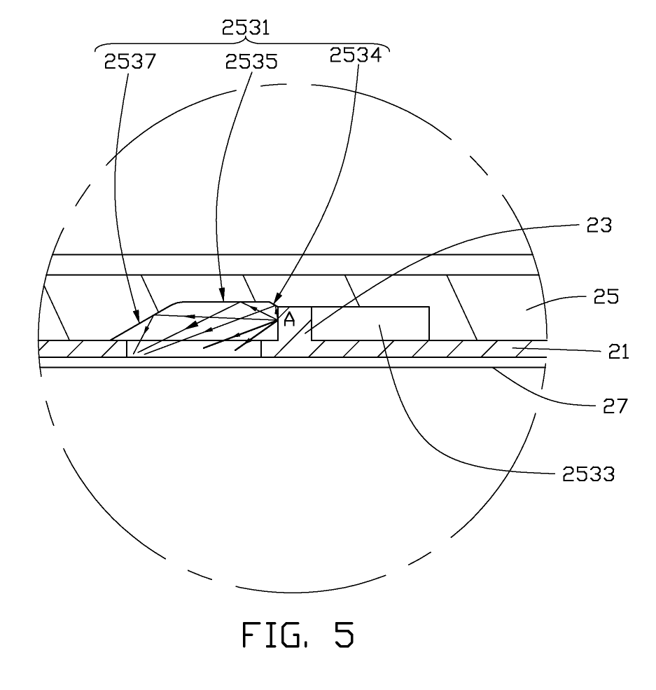

Referring to FIGS. 4 and 5, the reflecting portion 2531 includes a first reflecting surface 2534, a second reflecting surface 2535, and a third reflecting surface 2537. The second reflecting surface 2535 is a plane that is parallel to the circuit board 21. The first reflecting surface 2534 and the third reflecting surface 2537 are angled toward the second reflecting surface 2535. In the illustrated embodiment, the first reflecting surface 2534 meets the second reflecting surface 2535 at 45°, and the third reflecting surface 2537 meets the second reflecting surface 2535 at 30°.

Using point A of one light source 23 as an example, part of the light from the point A is directly incident on the marking patterns 273 of the marked strip 27 after passing through the through hole 211, and the other part of the light from the point A passes the through hole 211 to reach the marking patterns 273 after being reflected by the optical grooves 253. In detail, the light incident on the first reflecting surface 2534 and the second reflecting surface 2535 is reflected to the through hole 211 and away from the light source 23, thus reducing the brightness illuminated in the area which is adjacent to the light source 23. Light incident on the third reflecting surface 2537 is reflected to the through hole 211 and away from the light source 23, thus enhancing brightness illuminated in the area located farther away from the light source 23. Therefore, the backlit touch button assembly 200 provides improved illumination uniformity. It should be understood that the first reflecting surface 2534 and the third reflecting surface 2537 can intersect the second reflecting surface 2535 at different angles, and have different areas, such that the marking patterns 273 can be sufficiently illuminated by the light sources 23. In addition, the second reflecting surface 2535 can be a roughened surface to further diffuse the light.

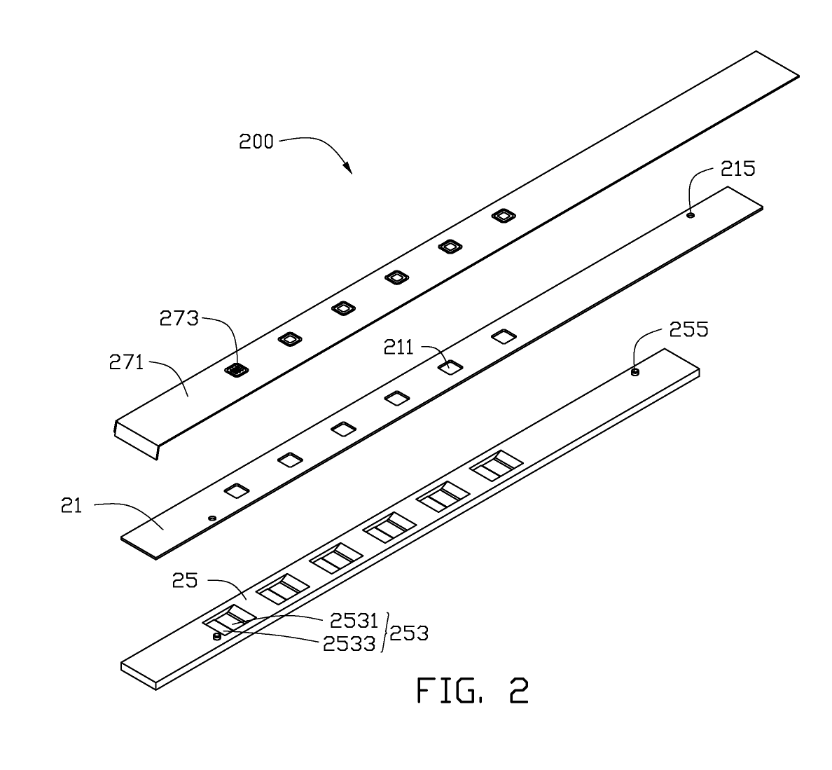

In the illustrated embodiment, two positioning poles 255 are formed on opposite sides of the reflecting plate 25, and the circuit board 21 defines two positioning holes 215, correspondingly (as shown in FIG. 2). Therefore, the reflecting plate 25 can be accurately assembled on the circuit board 21 by the positioning poles 255 extending through the positioning holes 215 of the circuit board 21.

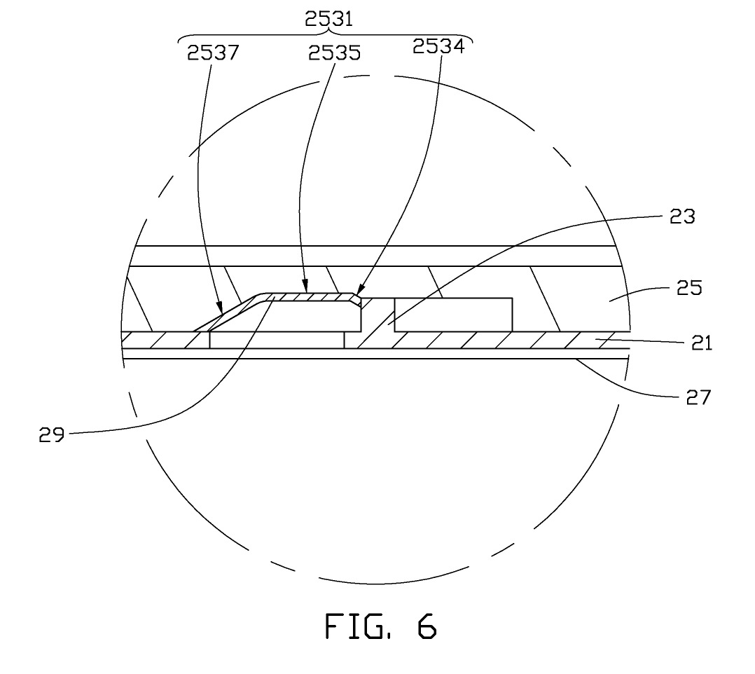

Referring to FIG. 6, in an alternative embodiment, a diffusing sheet 29 is received in the optical grooves 253, and the diffusing sheet 29 is attached to the first reflecting surface 2534, the second reflecting surface 2535, and the third reflecting surface 2537. The diffusing sheet 29 diffuses the light from the light sources 23.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A backlit touch button assembly, comprising:
a circuit board;
at least one light source positioned on the circuit board; and
a reflecting plate and a marked strip attached to opposite sides of the circuit board;
wherein the reflecting plate defines at least one optical groove receiving the at least one light source, the at least one optical groove comprises a reflecting portion, the circuit board defines at least one through hole adjacent to the at least one light source, and the at least one through hole corresponds to the reflecting portion, the reflecting portion comprises a first reflecting surface, a second reflecting surface, and a third reflecting surface, and the first reflecting surface and the third reflecting surface meet the second reflecting surface, respectively.

2. The backlit touch button assembly of claim 1, wherein the first reflecting surface meets the second reflecting surface at 45°.

3. The backlit touch button assembly of claim 2, wherein the third reflecting surface meets the second reflecting surface at 30°.

4. The backlit touch button assembly of claim 1, wherein each optical groove further comprises a receiving portion communicating with the reflecting portion and adjacent to the first reflecting surface.

5. The backlit touch button assembly of claim 4, wherein the second reflecting surface is a roughened surface.

6. The backlit touch button assembly of claim 1, further comprising a diffusing sheet received in the at least one optical groove.

7. The backlit touch button assembly of claim 6, wherein the diffusing sheet is attached to the first reflecting surface, the second reflecting surface, and the third reflecting surface.

8. The backlit touch button assembly of claim 1, wherein the at least one light source is a light emitting diode.

9. The backlit touch button assembly of claim 1, wherein two positioning poles are formed on opposite sides of the reflecting plate, the circuit board defines two positioning holes, and the positioning poles engage in the positioning holes of the circuit board.

10. The backlit touch button assembly of claim 1, wherein the at least one through hole is substantially rectangular.

11. A backlit touch button assembly, comprising:
a circuit board;
at least one light source positioned on the circuit board; and
a reflecting plate and a marked strip attached to opposite sides of the circuit board;
wherein the reflecting plate defines at least one optical groove receiving the at least one light source, the at least one optical groove comprises a reflecting portion, the circuit board defines at least one through hole adjacent to the at least one light source, the at least one through hole corresponding to the reflecting portion, the reflecting portion comprises a reflecting surface reflecting light emitted thereon to the at least one through hole and away from the at least one light source.

12. The backlit touch button assembly of claim 11, wherein each of the at least one optical grooves further comprises a receiving portion communicating with the reflecting portion and adjacent to the first reflecting surface.

13. The backlit touch button assembly of claim 12, wherein the second reflecting surface is a rough surface.

14. The backlit touch button assembly of claim 11, further comprising a diffusing sheet received in the at least one optical groove.

15. The backlit touch button assembly of claim 14, wherein the diffusing sheet is attached to the first reflecting surface, the second reflecting surface, and the third reflecting surface.

16. The backlit touch button assembly of claim 11, wherein the at least one light source is a light emitting diode.

17. The backlit touch button assembly of claim 11, wherein two positioning poles are formed on opposite sides of the reflecting plate and the circuit board defines two positioning holes receiving the positioning poles.

18. The backlit touch button assembly of claim 11, wherein the at least one through hole is substantially rectangular.
